(19) United States
(12) Patent Application Publication
(10) Pub. No.: US 2025/0319594 A1
(43) Pub. Date: Oct. 16, 2025

(54) MOBILE ROBOT AND METHOD FOR CONTROLLING MOBILE ROBOT

(71) Applicants: LG ELECTRONICS INC., Seoul (KR); KUMOH NATIONAL INSTITUTE OF TECHNOLOGY INDUSTRY-ACADEMIC COOPERATION FOUNDATION, Gumi-si, Gyeongsangbuk-do (KR)

(72) Inventors: Heoncheol LEE, Gumi-si (KR); Changhyeon LEE, Seoul (KR); Kahyung CHOI, Seoul (KR)

(73) Assignees: LG ELECTRONICS INC., Seoul (KR); KUMOH NATIONAL INSTITUTE OF TECHNOLOGY INDUSTRY-ACADEMIC COOPERATION FOUNDATION, Gumi-si, Gyeongsangbuk-do (KR)

(21) Appl. No.: 18/867,188

(22) PCT Filed: May 4, 2023
(86) PCT No.: PCT/KR2023/006094

§ 371 Date: Nov. 19, 2024

(30) Foreign Application Priority Data
May 19, 2022 (KR) 10-2022-0061570

(51) Int. Cl. B25J 9/16; B25J 5/00; B25J 13/08; B25J 19/02

(52) U.S. Cl. CPC B25J 9/1666; B25J 5/007; B25J 13/08; B25J 19/022

(57) ABSTRACT

The present disclosure relates to a mobile robot including: a main body; a traveling unit configured to move the main body; a sensing unit configured to obtain terrain information outside the main body; and a controller which is configured to determine whether a current location of the main body is a corner in a traveling area based on the terrain information obtained by the sensing unit, and which in response to the main body being positioned at the corner, is configured to control a motion for obtaining corner surrounding information to be performed, at the corner, to obtain terrain information around the corner by the sensing unit.

### TECHNICAL FIELD

The following description relates to a robot cleaner and a method of controlling the robot cleaner, and more particularly to Simultaneous Localization and Mapping (SLAM) traveling technology.

### BACKGROUND ART

Robots have been developed for industrial use and have been part of factory automation.

Recently, the application field of robots has been expanded, such that medical robots, aerospace robots, and the like have been developed and household robots that can be used in ordinary houses have also been manufactured. Among these robots, a robot that can travel by itself is called a mobile robot. A typical example of the mobile robot used in home is a robot cleaner.

There are many known techniques for sensing the surroundings of a mobile robot and a user by using various sensors provided for the mobile robot. Further, there are also techniques for allowing the mobile robot to learn and map an area to be cleaned and identify a current position on the map. There is known a mobile robot that travels in an area to be cleaned in a preset manner for cleaning the area to be cleaned.

Furthermore, a prior art (Korean Laid-open Patent Publication No. 10-2008-0090925) discloses a technique for traveling in a zigzag pattern along a wall surface on the outside of the area to be cleaned while traveling by itself in the area.

Meanwhile, a method for determining and avoiding obstacles while traveling is required if there is an obstacle when a robot cleaner performs mapping.

A prior art (U.S. Pat. No. 7,211,980B1) discloses a technique in which a robot receives a target bearing and senses whether there is an obstacle in front of the robot, and if there is an obstacle in front of the robot, the robot avoids a nearest obstacle by adjusting at least one of a rotational direction, rotational speed, switching direction, and switching speed. However, in the prior art, the robot moves by a simple logic based on the position of a recognized obstacle, such that it is difficult to respond to an obstacle which is not recognized by the robot or an obstacle having no directionality. Further, the prior art has a problem in that the method focuses on obstacle avoidance, which may lead to inefficient motion if an obstacle is complicated.

### PRIOR ART DOCUMENT

### Patent Document

(Patent literature 1) Korean Laid-open Patent Publication No. 10-2008-0090925 (published on Oct. 19, 2008)
(Patent literature 2) U.S. Pat. No. 7,211,980B1 (published on Jan. 5, 2007)

### DISCLOSURE OF INVENTION

### Technical Problem

It is a first object of the present disclosure to provide a mobile robot capable of performing accurate simultaneous localization and mapping (SLAM) even by using only a laser-based sensor while reducing the number of sensors in the mobile robot.

It is a second object of the present disclosure to provide a mobile robot in which, when a robot cleaner travels for drawing a map in the case where there is no map, the mobile robot is capable of drawing an accurate map with a minimum number of sensors.

It is a third object of the present disclosure to correct traveling of a mobile robot by accurately estimating a current location of the mobile robot at a corner in the case where there is a map.

It is a fourth object of the present disclosure to provide a mobile robot capable of estimating a current location thereof, with a small number of sensing elements for generating a map and less control overhead on a controller.

### Technical Solution

The present disclosure provides a mobile robot including: a main body; a traveling unit configured to move the main body; a sensing unit configured to obtain terrain information outside the main body; and a controller which is configured to determine whether a current location of the main body is a corner in a traveling area based on the terrain information obtained by the sensing unit, and which in response to the main body being positioned at the corner, is configured to control a motion for obtaining corner surrounding information to be performed at the corner to obtain terrain information around the corner by the sensing unit.

The motion for obtaining the corner surrounding information may be performed in such a manner that the main body rotates at the corner to obtain external terrain information by the sensing unit.

The motion for obtaining the corner surrounding information may be performed in such a manner that the main body rotates in a first direction at the corner, and then rotates in a second direction opposite to the first direction, to obtain external terrain information by the sensing unit.

The first direction and the second direction may be orthogonal to a traveling direction of the main body.

The second direction may match a traveling direction after the main body travels around the corner.

The sensing unit may include a laser sensor for obtaining terrain information within a predetermined angle with respect to the traveling direction of the main body.

The motion for obtaining the corner surrounding information may include obtaining the terrain information by extracting distances to feature points of a wall within a predetermined distance or a predetermined angle from the corner.

The controller may be configured to estimate an inclination of the wall based on the distances to the feature points of the wall, and to update the inclination of the wall in a map.

The controller may be configured to estimate a current location of the main body based on the distances to the feature points of the wall.

The controller may be configured to estimate an inclination of the wall based on the distances to the feature points of the wall, and to determine a heading direction of the main body based on the inclination of the wall.

The controller may be configured to estimate a current location of the main body based on the terrain information around the corner obtained by performing the motion for obtaining the corner surrounding information.

The mobile robot may further include a storage unit configured to store data, wherein the controller may be configured to update the map based on the terrain information around the corner obtained by performing the motion for obtaining the corner surrounding information.

The controller may be configured to generate a map based on terrain information around a plurality of corners and position information of the plurality of corners, the terrain information and the position information being obtained by performing the motion for obtaining the corner surrounding information.

The controller may be configured to estimate a current location of the main body based on the terrain information around the corner obtained by performing the motion for obtaining the corner surrounding information.

The controller may be configured to perform the motion for obtaining the corner surrounding information during wall following traveling of the main body.

In addition, the present disclosure provides a method for controlling a mobile robot, the method including: a terrain information obtaining step of obtaining, by a sensing unit, terrain information around a main body; a corner determining step of determining whether a current location of the main body is a corner in a traveling area; and a corner surrounding terrain information obtaining step of obtaining, at the corner, terrain information around the corner in response to the current location of the main body being the corner.

The corner surrounding terrain information obtaining step may include obtaining external terrain information by the sensing unit while the main body rotates at the corner.

In addition, the method may further include a current location estimating step of estimating a current location of the main body based on the terrain information around the corner.

In addition, the method may further include a map updating step of updating a map based on the terrain information around the corner.

The corner surrounding terrain information obtaining step may include extracting distances to feature points of a wall within a predetermined distance and a predetermined angle from the corner.

### Advantageous Effects

In the present disclosure, SLAM may be performed by using only one to three laser-based obstacle detection sensors 171 installed on the main body, such that the current location of the mobile robot may be accurately estimated at the corner while reducing manufacturing costs of the mobile robot, thereby achieving the effect of accurate and rapid traveling.

In addition, the present disclosure has an effect in that, when a robot cleaner travels for drawing a map in the case where there is no map, the robot cleaner may provide an accurate map using a minimum number of sensors, and map drawing time may be reduced.

Further, in the present disclosure, a mobile robot obtains surrounding information of the corner while rotating 270 degrees at the corner, thereby achieving the effect of reducing cleaning time and sensing time compared to a 360-degree rotation, and a direction angle of the mobile robot after completing the rotation is the heading direction of the mobile robot, thereby achieving the effect of increasing cleaning efficiency.

In addition, the present disclosure has an effect in that a mobile robot estimates a current location thereof, with a small number of sensing elements for generating a map and less control overhead on a controller.

Meanwhile, various other effects will be explicitly or implicitly disclosed in the following detailed description of embodiments of the present disclosure.

### DESCRIPTION OF DRAWINGS

FIG. 1 is s a perspective view of a mobile robot and a charging stand for charging the mobile robot according to an embodiment of the present disclosure.

FIG. 2 is a block diagram illustrating a control relationship between main components of a mobile robot according to an embodiment of the present disclosure.

FIG. 3 is a flowchart illustrating a method for controlling a mobile robot according to an embodiment of the present disclosure.

FIGS. 4 to 6 are diagrams referred to in the description of the controlling method of FIG. 3.

FIG. 7 is a diagram illustrating the concept of updating a position of a mobile robot based on terrain information around a corner.

FIG. 8 is a diagram illustrating a method of controlling a mobile robot according to another embodiment of the present disclosure.

FIG. 9 is a diagram explaining a loop closing method of the present disclosure.

### BEST MODE FOR CARRYING OUT THE INVENTION

Reference will now be made in detail to the example embodiments of the present invention, examples of which are illustrated in the accompanying drawings. However, it will be understood that the present disclosure should not be limited to the embodiments and may be modified in various ways.

Terms “module” and “unit” for elements used in the following description are given simply in view of the ease of the description, and do not carry any important meaning or role. Therefore, the “module” and the “part” may be used interchangeably.

It will be understood that, although the terms first, second, etc., may be used herein to describe various elements, these elements should not be limited by these terms. These terms are only used to distinguish one element from another.

In addition, a mobile robot 100 according to an embodiment of the present disclosure refers to a robot capable of moving by itself with wheels and the like, and examples thereof may include a home helper robot, a robot cleaner, and the like. As an example of the mobile robot 100, a robot cleaner having a cleaning function will be described below with reference to the accompanying drawings, but the present disclosure is not limited thereto.

The mobile robot 100 refers to a robot capable of moving by itself with wheels and the like. Accordingly, the mobile robot 100 may be a guide robot, a a cleaning robot, an entertainment robot, a home helper robot, a security robot, etc., which can move by itself, and the present disclosure is not limited to the type of the mobile robot 100.

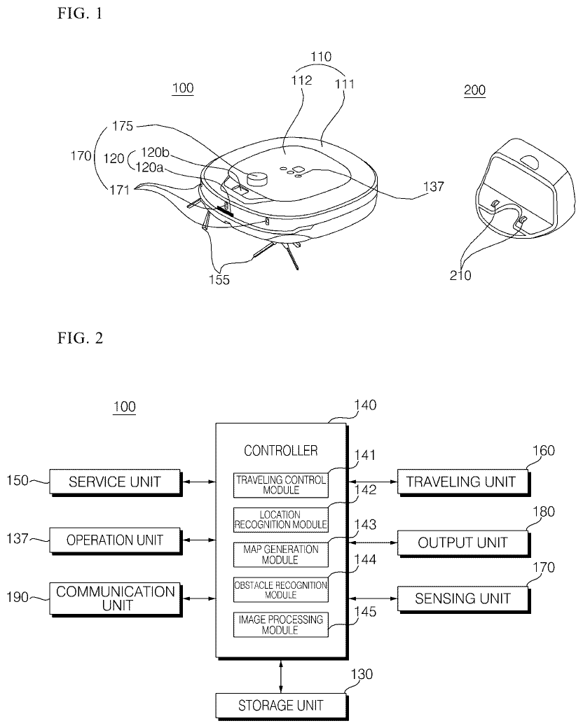

FIG. 1 illustrates the mobile robot 100 which is a cleaning robot, as an embodiment of the present disclosure.

The mobile robot 100 may be provided with a cleaning mechanism 155, such as a brush and the like, to clean a specific space while moving by itself.

The mobile robot 100 includes sensing units 170: 171 and 175 capable of detecting information about the surroundings.

The mobile robot 100 effectively fuses vision-based localization technique using a camera and LiDAR-based localization technique using a laser to perform location recognition and map generation that are robust to environmental changes, such as changes in illuminance or changes in the location of the object, and the like.

In addition, the mobile robot 100 may perform location recognition and map generation by using the LiDAR-based localization technique using a laser.

An image acquirer 120 photographs a traveling area, and may include one or more camera sensors for acquiring an image outside a main body 110.

Further, the image acquirer 120 may include a camera module. The camera module may include a digital camera. The digital camera may include at least one optical lens, an image sensor (e.g., CMOS image sensor) including a plurality of photodiodes (e.g., pixel) imaged by light passing through the optical lens, and a digital signal processor (DSP) for generating an image based on a signal output from the photodiodes. The DSP may generate a moving image including frames composed of still images, as well as a still image.

In this embodiment, the image acquirer 120 includes a front camera sensor configured to acquire an image in front of the main body 110, but the location and the photographing range of the image acquirer 120 is not necessarily limited thereto.

For example, the mobile robot 100 includes only a camera sensor for acquiring a front image in the traveling area and perform vision-based location recognition and traveling.

Alternatively, the image acquirer 120 of the mobile robot 100 according to an embodiment of the present disclosure may include a camera sensor (not shown) that is disposed obliquely with respect to one surface of the main body 110 and configured to photograph the front side and the top side together. That is, it is possible to photograph both the front side and the top side with a single camera sensor. In this case, the controller 140 may separate the front image and the upper image from the image acquired by the camera based on the angle of view.

The separated front image may be used for vision-based object recognition with the image obtained from the front camera sensor. In addition, the separated upper image may be used for vision-based location recognition and traveling with the image acquired from an upper camera sensor.

The mobile robot 100 according to the present disclosure may implement vision SLAM that recognizes the current location by comparing surrounding images with image-based pre-stored information or comparing acquired images.

Meanwhile, the image acquirer 120 may also include a plurality of front camera sensors and/or upper camera sensors. Alternatively, the image acquirer 120 may be provided with a plurality of camera sensors (not shown) configured to photograph the front and the top together.

In this embodiment, a camera is installed on a part (ex, front, rear, bottom) of the mobile robot 100, and the captured image may be continuously acquired during cleaning. Multiple cameras may be installed for each part to improve photographing efficiency. The image captured by the camera can be used to recognize the type of material such as dust, hair, floor, or the like present in the space, to check whether it is cleaned, or when to clean.

The front camera sensor may photograph a situation of an obstacle or a cleaning area existing in the front of the traveling direction of the mobile robot 100.

According to an embodiment of the present disclosure, the image acquirer 120 may acquire a plurality of images by continuously photographing the periphery of the main body 110, and the acquired plurality of images may be stored in a storage unit.

The mobile robot 100 may increase the accuracy of obstacle recognition by using a plurality of images or may increase the accuracy of obstacle recognition by selecting one or more images from among a plurality of images and using effective data.

A sensing unit 170 may include a lidar sensor 175 that acquires terrain information outside the main body 110 by using a laser.

The lidar sensor 175 outputs the laser to provide information such as a distance, a location direction, and a material of the object that reflects the laser and may acquire terrain information of the traveling area. The mobile robot 100 may obtain 360-degree geometry information using the lidar sensor.

The mobile robot 100 according to an embodiment of the present disclosure may identify the distance, location, and direction of objects sensed by the lidar sensor 175 and generate a map while travelling accordingly.

The mobile robot 100 according to an embodiment of the present disclosure may acquire terrain information of the traveling area by analyzing the laser reception pattern such as a time difference or signal intensity of the laser reflected and received from the outside. In addition, the mobile robot 100 may generate the map using terrain information obtained by the lidar sensor 175.

For example, the mobile robot 100 according to an embodiment of the present disclosure may perform LiDAR SLAM of recognizing the current location by comparing the surrounding terrain information obtained by the lidar sensor 175 at the current location with the lidar sensor-based pre-stored terrain information or comparing the obtained terrain information.

More preferably, the mobile robot 100 according to an embodiment of the present disclosure effectively fuses vision-based localization technique using a camera and LiDAR-based localization technique using a laser to perform location recognition and map generation that are robust to environmental changes, such as changes in illuminance or changes in the location of the object, and the like.

Meanwhile, the sensor unit 170 may include sensors 171 for sensing various data related to the operation and state of the mobile robot 100.

For example, the sensing unit 170 may include an obstacle detection sensor 171 that detects an obstacle in front. In addition, the sensing unit 170 may further include a cliff detection sensor for detecting the presence of a cliff on the floor in the traveling area, and a lower camera sensor for acquiring an image of the floor.

Referring to FIG. 1, the obstacle detection sensor 171 may include a plurality of sensors installed at regular intervals on the outer circumferential surface of the mobile robot 100.

The obstacle detection sensor 171 may include an infrared sensor, an ultrasonic sensor, an RF sensor, a geomagnetic sensor, a Location Sensitive Device (PSD) sensor, and the like.

Particularly, in the present disclosure, the obstacle detection sensor 171 may include a laser sensor for acquiring terrain information within a predetermined angle with respect to a traveling direction of the main body 110.

Meanwhile, the position and type of the sensor included in the obstacle detection sensor 171 may vary depending on the type of the mobile robot 100, and the obstacle detection sensor 171 may further include various sensors.

The obstacle detection sensor 171 is a sensor that detects a distance from an indoor wall or the obstacle, and the present disclosure is not limited to that type, but will be described below by using an ultrasonic sensor as an example.

The obstacle detection sensor 171 detects the object, particularly an obstacle, present in the traveling (movement) direction of the mobile robot 100, and transmits obstacle information to the controller 140. That is, the obstacle detection sensor 171 may detect a projecting object, an object in the house, furniture, a wall, a wall edge, and the like, present on a movement path of the mobile robot 100 and at the front or side thereof, and transmit the information to a control unit.

The mobile robot 100 may be provided with a display (not shown) to display a predetermined image such as a user interface screen. In addition, the display may be configured as a touch screen to be used as an input means.

In addition, the mobile robot 100 may receive user input through touch, voice input, or the like, and display information on the object and a place corresponding to the user input on the display screen.

The mobile robot 100 may perform an assigned task, that is, cleaning while traveling in a specific space. The mobile robot 100 may perform autonomous traveling by generating a path to a predetermined destination on its own, and may perform following traveling by moving while following a person or another robot. In order to prevent the occurrence of a safety accident, the mobile robot 100 may travel while detecting and avoiding the obstacle during movement based on the image data acquired through the image acquirer 120, the detection data obtained from the sensing unit 170, and the like.

The mobile robot 100 of FIG. 1 may be a cleaner robot 100 capable of providing cleaning services in various spaces, for example, spaces such as airports, hotels, marts, clothing stores, logistics, hospitals, and especially large areas such as commercial spaces.

The mobile robot 100 may be linked to a server (not shown) that may manage and control it.

The server may remotely monitor and control the states of a plurality of robots 100 and provide an effective service.

The mobile robot 100 and the server may be provided with communication means (not shown) supporting one or more communication standards to communicate with each other. In addition, the mobile robot 100 and the server may communicate with a PC, a mobile terminal, and other external servers. For example, the mobile robot 100 and the server may communicate using a Message Queuing Telemetry Transport (MQTT) method or a HyperText Transfer Protocol (HTTP) method. Further, the mobile robot 100 and the server may communicate with a PC, a mobile terminal, or another external server using the HTTP or MQTT method.

In some cases, the mobile robot 100 and the server support two or more communication standards and may use an optimal communication standard according to the type of communication data and the type of devices participating in the communication.

The server is implemented as a cloud server, and a user can use data stored and functions and services provided by the server through the server connected to various devices such as a PC and a mobile terminal.

A user may check or control information about the mobile robot 100 in the robot system through the PC, the mobile terminal, or the like.

In this specification, “user” is a person who uses a service through at least one robot, an individual customer who purchases or rents a robot and uses it at home, and a manager of a company that provides services to employees or customers using the robot, the employees and the customers using the services provided by the company. Accordingly, the “user” may include an individual customer (Business to Consumer: B2C) and an enterprise customer (Business to Business: B2B).

The user may monitor the status and location of the mobile robot 100 through the PC, the mobile terminal, and the like, and may manage content and a work schedule. Meanwhile, the server may store and manage information received from the mobile robot 100 and other devices.

The mobile robot 100 and the server may be provided with communication means (not shown) supporting one or more communication standards to communicate with each other. The mobile robot 100 may transmit data related to space, objects, and usage to the server.

Here, the data related to the space and object are data related to the recognition of the space and objects recognized by the robot 100, or may be image data for the space and the object obtained by the image acquirer 120.

In some embodiments, the mobile robot 100 and the server may include artificial neural networks (ANN) in the form of software or hardware trained to recognize at least one of the user, a voice, an attribute of space, and attributes of objects such as the obstacle.

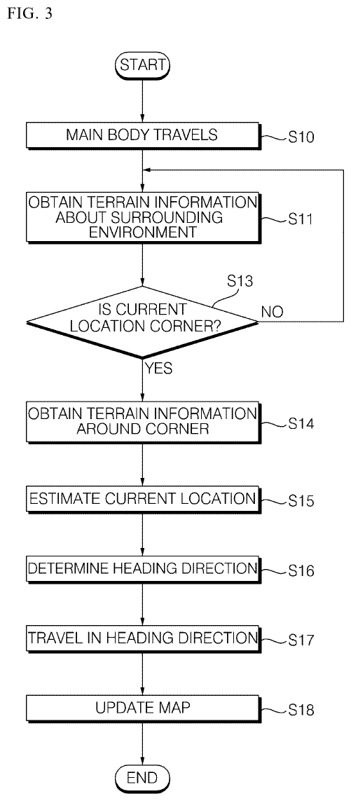

According to an embodiment of the present disclosure, the mobile robot 100 and the server may include a deep neural network (DNN), such as Convolutional Neural Network (CNN), Recurrent Neural Network (RNN), and Deep Belief Network (DBN) trained through Deep Learning. For example, the deep neural network (DNN) structure, such as a convolutional neural network (CNN) and the like, may be installed on the controller 140 (see FIG. 2) of the robot 100.

The server may train the deep neural network (DNN) based on data received from the mobile robot 100, data input by the user, etc., and then may transmit updated DNN structure data to the robot 100. Accordingly, the deep neural network (DNN) structure of artificial intelligence included in the mobile robot 100 may be updated.

In addition, usage-related data is data obtained as a result of using a predetermined product, for example, the robot 100, and may correspond to usage history data, sensing data obtained from the sensing unit 170, and the like.

The trained deep neural network structure (DNN) may receive input data for recognition, may recognize attributes of people, objects, and spaces included in the input data, and may output the result.

In addition, the trained deep neural network structure (DNN) may receive input data for recognition, may analyze and learn usage-related data of the mobile robot 100, and may recognize usage patterns, usage environments, and the like.

Meanwhile, data related to space, objects, and usage may be transmitted to the server through a communication unit 190 (see FIG. 2).

The server trains the DNN based on the received data, and then transmits the updated deep neural network (DNN) structure data to the mobile robot 100 for updating.

Accordingly, the mobile robot 100 becomes smarter and provides a user experience (UX) that evolves as it is used.

The robot 100 and the server 10 may also use external information. For example, the server 10 may comprehensively use external information obtained from other linked service servers 20 and 30 to provide an excellent user experience.

According to the present disclosure, the mobile robot 100 and/or the server may perform speech recognition, so that the user voice may be used as an input for controlling the robot 100.

In addition, according to the present disclosure, the mobile robot 100 may provide a more diverse and active control function to the user by actively providing information or outputting a voice recommending a function or service.

FIG. 2 is a block diagram illustrating a control relationship between main components of the mobile robot 100 according to an embodiment of the present disclosure. The block diagram of FIG. 2 may be applied to both the mobile 100 of FIG. 1 and the mobile robot 100 of FIG. 1, and will be described below along with the configuration of the mobile robot 100 of FIG. 1.

Referring to FIG. 1, the mobile robot 100 includes a traveling unit 160 that moves the main body 110. The traveling unit 160 includes at least one traveling wheel 136 that moves the main body 110. The traveling unit 160 includes a traveling motor (not shown) connected to the traveling wheel 136 to rotate the traveling wheel. For example, the traveling wheels 136 may be provided on the left and right sides of the main body 110, respectively, and will be referred to as the left wheel L and the right wheel R, respectively, in the following description.

The left wheel L and the right wheel R may be driven by one traveling motor, but a left wheel traveling motor driving the left wheel L and a right wheel traveling motor driving the right wheel R may be provided as needed. The traveling direction of the main body 110 may be switched to the left or right side by using different rotational speeds for the left wheel L and the right wheel R.

The mobile robot 100 includes a service unit 150 for providing a predetermined service. FIGS. 1 and 1 illustrate an example in which the service unit 150 performs a cleaning operation, but the present disclosure is not limited thereto. For example, the service unit 150 may be provided to provide a user with household services such as cleaning (scrubbing, suction cleaning, mopping, etc.), washing dishes, cooking, doing the laundry, and garbage disposal. In another example, the service unit 150 may perform a security function for detecting external intruders or dangerous situations.

The mobile robot 100 may clean the floor through the service unit 150 while moving in a traveling area. The service unit 150 includes a suction device for suctioning foreign matter, brushes 135 and 155 for performing sweeping, a dust container (not shown) for storing the foreign matter collected by the suction device or the brushes, and/or a mopping unit (not shown) for performing mopping.

A suction port for suctioning air may be formed in a bottom part of the main body 110 of the mobile robot 100 of FIG. 1. The main body 110 may include a suction device (not shown) for supplying suction force for suctioning air through the suction port, and a dust container (not shown) for collecting dust suctioned through the suction port together with the air.

The main body 110 may include a case 111 defining a space in which various components constituting the mobile robot 100 are accommodated. The case 111 may have an opening for insertion and removal of the dust container, and a dust container cover 112 for opening and closing the opening may be rotatably provided in the case 111.

A roll type main brush having brushes exposed through the suction port, and an auxiliary brush 155 which is located on the front side of the bottom part of the main body 110 and has a brush formed of a plurality of radially extending wings. By the rotation of the brushes 155, dust is separated from the floor in a traveling area, and the dust separated from the floor is suctioned through the suction port and collected in the dust container.

A battery may supply power required not only for the driving motor but also for the overall operation of the mobile robot 100. When the battery is discharged, the mobile robot 100 may travel to return to a charging stand 200 for charging. During returning, the mobile robot 100 may automatically detect the location of the charging stand 200.

The charging stand 200 may include a signal transmitter (not shown) for transmitting a certain return signal. The return signal may be an ultrasound signal or an infrared signal, but the present disclosure is not limited thereto.

The mobile robot 100 of FIG. 1 may include a signal sensor (not shown) for receiving the return signal. The charging stand 200 may transmit an infrared signal through the signal transmitter, and the signal sensor may include an infrared sensor for sensing the infrared signal. The mobile robot 100 moves to the location of the charging stand 200 according to the infrared signal transmitted from the charging stand 200 and docks with the charging stand 200. By the docking, charging may be achieved between a charging terminal of the mobile robot 100 and a charging terminal 210 of the charging stand 200.

The mobile robot 100 may include a sensing unit 170 for sensing information about the inside/outside of the mobile robot 100.

For example, the sensing unit 170 may include one or more sensors 171 and 175 for sensing various types of information about a traveling area and an image acquirer 120 for acquiring image information about the traveling area. In some embodiments, the image acquirer 120 may be provided separately outside the sensing unit 170.

The mobile robot 100 may map the traveling area based on the information sensed by the sensing unit 170. For example, the mobile robot 100 may perform vision-based location recognition and map generation based on the ceiling image of the travelling area acquired by the image acquirer 120. In addition, the mobile robot 100 may perform location recognition and map generation based on a light detection and ranging (LiDAR) sensor using a laser.

More preferably, the mobile robot 100 according to the present disclosure effectively fuses vision-based localization technique using a camera and LiDAR-based localization technique using a laser to perform location recognition and map generation that are robust to environmental changes, such as changes in illuminance or changes in the location of the object, and the like.

Meanwhile, the image acquirer 120 photographs a traveling area, and may include one or more camera sensors for acquiring an image outside a main body 110.

Further, the image acquirer 120 may include a camera module. The camera module may include a digital camera. The digital camera may include at least one optical lens, an image sensor (e.g., CMOS image sensor) including a plurality of photodiodes (e.g., pixel) imaged by light passing through the optical lens, and a digital signal processor (DSP) for generating an image based on a signal output from the photodiodes. The DSP may generate a moving image including frames composed of still images, as well as a still image.

In this embodiment, the image acquirer 120 may include a front camera sensor 120a configured to acquire an image of the front of the main body 110 and an upper camera sensor 120b provided at the upper part of the main body 110 to acquire an image of a ceiling in the traveling area, but the location and photographing range of the image acquirer 120 are not necessarily limited thereto.

For example, the mobile robot 100 may be equipped with only the upper camera sensor 120b for acquiring an image of the ceiling in the traveling area, and perform vision-based location recognition and travelling.

Alternatively, the image acquirer 120 according to an embodiment of the present disclosure may include a camera sensor (not shown) that is disposed obliquely with respect to one surface of the main body 110 and configured to photograph the front side and the top side together. That is, it is possible to photograph both the front side and the top side with a single camera sensor. In this case, the controller 140 may separate the front image and the upper image from the image acquired by the camera based on the angle of view. The separated front image may be used for vision-based object recognition with the image obtained from the front camera sensor 120a. In addition, the separated upper image may be used for vision-based location recognition and travelling, such as an image obtained from the upper camera sensor 120b.

The mobile robot 100 according to the present disclosure may perform vision SLAM of recognizing the current location by comparing surrounding images with pre-stored information based on images or comparing acquired images.

Meanwhile, the image acquirer 120 may also be provided with a plurality of front camera sensors 120a and/or upper camera sensors 120b. Alternatively, the image acquirer 120 may also be provided with a plurality of camera sensors (not shown) configured to photograph the front and the top together.

In this embodiment, a camera is installed on a part (ex, front, rear, bottom) of the mobile robot 100, and the captured image may be continuously acquired during cleaning. Multiple cameras may be installed for each part to improve photographing efficiency. The image captured by the camera can be used to recognize the type of material such as dust, hair, floor, or the like present in the space, to check whether it is cleaned, or when to clean.

The front camera sensor 120a may photograph the obstacle existing in the front of the traveling direction of the mobile robot 100 or a situation of a cleaning area.

According to an embodiment of the present disclosure, the image acquirer 120 may acquire a plurality of images by continuously capturing a plurality of images of the surroundings of the main body 110, and the acquired images may be stored in the storage unit 130.

The mobile robot 100 may increase the accuracy of obstacle recognition by using a plurality of images, or may increase the accuracy of obstacle recognition by selecting one or more images from among a plurality of images and using effective data.

The sensing unit 170 may include a lidar sensor 175 that acquires terrain information outside the main body 110 using a laser.

The lidar sensor 175 outputs laser to provide information such as a distance, a location direction, and a material of an object that reflects the laser and may acquire terrain information of the traveling area. The mobile robot 100 may obtain 360-degree geometry information with the lidar sensor 175.

The mobile robot 100 according to the embodiment of the present disclosure may generate a map by identifying the distance, location, and direction of objects sensed by the lidar sensor 175.

The mobile robot 100 according to an embodiment of the present disclosure may acquire terrain information of the traveling area by analyzing a laser reception pattern such as a time difference or signal intensity of a laser reflected and received from the outside. In addition, the mobile robot 100 may generate the map using terrain information obtained by the lidar sensor 175.

For example, the mobile robot 100 may perform LiDAR SLAM of determining the moving direction by analyzing surrounding terrain information obtained at the current location by the lidar sensor 175.

More preferably, the mobile robot 100 according to the present disclosure may effectively recognize obstacles and generate the map by extracting an optimal moving direction with a small amount of change using a vision-based location recognition using the camera and a lidar-based location recognition technology using the laser and an ultrasonic sensor.

Meanwhile, the sensing unit 170 may include sensors 171, 172, and 179 for sensing various data related to the operation and state of the mobile robot 100.

For example, the sensing unit 170 may include an obstacle detection sensor 171 that detects an obstacle in front. In addition, the sensing unit 170 may further include a cliff detection sensor 172 for detecting the presence of a cliff on the floor in the traveling area, and a lower camera sensor 179 for acquiring an image of the floor.

The obstacle detection sensor 171 may include a plurality of sensors installed at regular intervals on the outer circumferential surface of the mobile robot 100.

The obstacle detection sensor 171 may include an infrared sensor, an ultrasonic sensor, an RF sensor, a geomagnetic sensor, a Location Sensitive Device (PSD) sensor, and the like.

Meanwhile, the location and type of the sensor included in the obstacle detection sensor 171 may vary depending on the type of the mobile robot 100, and the obstacle detection sensor 171 may further include various sensors.

The obstacle detection sensor 171 is a sensor that detects a distance from an indoor wall or the obstacle, and the present disclosure is not limited to that type but will be described below by using an ultrasonic sensor as an example.

The obstacle detection sensor 171 detects the object, particularly an obstacle, present in the traveling (movement) direction of the mobile robot 100 and transmits obstacle information to the controller 140. That is, the obstacle detection sensor 171 may detect a projecting object, an object in the house, furniture, a wall, a wall edge, and the like, present on a movement path of the mobile robot 100 and at the front or side thereof, and transmit the information to the controller 140.

In this case, the controller 140 detects the location of the obstacle based on at least one or more signals received through the ultrasonic sensor, and controls the movement of the mobile robot 100 based on the detected location of the obstacle to provide an optimal movement path when generating the map.

In some embodiments, the obstacle detection sensor 131 provided on the outer surface of the case 110 may include a transmitter and a receiver.

For example, the ultrasonic sensor may be provided such that at least one transmitter and at least one or more receivers are staggered. Accordingly, signals may be radiated at various angles, and signals reflected by obstacles may be received at various angles.

In some embodiments, the signal received from the obstacle detection sensor 171 may be subjected to signal processing such as amplification and filtering, and then a distance and direction to the obstacle may be calculated.

Meanwhile, the sensing unit 170 may further include a traveling detection sensor that detects a traveling operation of the mobile robot 100 according to traveling of the main body 110 and outputs operation information. As the traveling sensor, a gyro sensor, a wheel sensor, an acceleration sensor, or the like may be used.

The mobile robot 100 may further include a battery detection unit (not shown) that detects a state of charge of the battery and transmits the detection result to the controller 140. The battery is connected to the battery detection unit so that the battery level and charge status are transmitted to the controller 140. The remaining battery power may be displayed on the screen of the output unit (not shown).

In addition, the mobile robot 100 includes an operation unit 137 capable of inputting on/off or various commands. Various control commands necessary for the overall operation of the mobile robot 100 may be received through the operation unit 137. In addition, the mobile robot 100 may include an output unit (not shown), and display reservation information, battery status, operation mode, operation status, and error status, and the like.

Referring to FIG. 2, the mobile robot 100 includes the controller 140 for processing and determining a variety of information such as recognizing a current location and the like, and the storage unit 130 for storing various data. In addition, the mobile robot 100 may further include a communication unit 190 that transmits and receives data to and from other devices.

Among the devices that communicate with the mobile robot 100, an external terminal has an application for controlling the mobile robot 100, and by executing the application, the mobile robot 100 displays the map of the traveling area to be cleaned, and specifies an area on the map to clean a specific area. A user terminal may communicate with the mobile robot 100 to display the current location of the mobile robot 100 along with the map, and information on a plurality of areas may be displayed. In addition, the user terminal updates and displays the location of the mobile robot according to the movement of the mobile robot 100.

The controller 140 may control the overall operation of the mobile robot 100 by controlling the sensing unit 170, the operation unit 137, and the traveling unit 160.

The storage unit 130 records a variety of information required for controlling the mobile robot 100, and may include a volatile or nonvolatile recording medium. The recording medium stores data that can be read by a microprocessor and is not limited to the type or implementation method.

In addition, the map of the traveling area may be stored in the storage unit 130. The map may be input by the user terminal, the server, or the like capable of exchanging information with the mobile robot 100, through wired or wireless communication or the mobile robot 100 may generate the map by learning by itself. The location of the rooms in the traveling area may be displayed on the map. In addition, the current location of the mobile robot 100 may be displayed on the map, and the current location of the mobile robot 100 on the map may be updated during traveling. The external terminal stores the same map as the map stored in the storage unit 130.

The storage unit 130 may store cleaning history information. The cleaning history information may be generated each time cleaning is performed.

The map of the traveling area stored in the storage unit 130 includes a navigation map used for traveling during cleaning, a Simultaneous localization and mapping (SLAM) map used for location recognition, a learning map for storing information when hitting an obstacle and the like for use during cleaning for learning, a global location map used for global location recognition, and an obstacle recognition map in which information about the recognized obstacle is recorded, and the like.

Meanwhile, as described above, maps may be separately stored and managed for each usage in the storage unit 130 but the map may not be clearly classified by use. For example, a plurality of pieces of information may be stored in one map to be used for at least one or more purposes.

The controller 140 may include a traveling control module 141, a location recognition module 142, a map generation module 143, and an obstacle recognition module 144.

The traveling control module 141 controls traveling of the mobile robot 100, and controls traveling of the traveling unit 160 according to the traveling setting. In addition, the traveling control module 141 may identify the traveling route of the mobile robot 100 based on the operation of the traveling unit 160. For example, the traveling control module 141 may identify the current or previous moving speed, the distance traveled, etc. of the mobile robot 100, and may also identify the history of changing the current or previous direction based on the rotational speed of each traveling wheel. The location of the mobile robot 100 on the map may be updated based on the identified traveling information of the mobile robot 100.

The map generation module 143 may generate the map of the traveling area. The map generation module 143 may process an image acquired through the image acquirer 120 to generate the map. For example, the map corresponding to the traveling area and the cleaning map corresponding to the cleaning area may be generated.

In addition, the map generation module 143 may recognize the global location by processing the image acquired through the image acquirer 120 at each location and linking it with the map.

In addition, the map generation module 143 may generate the map based on information obtained through the lidar sensor 175, and recognize a location based on the information obtained through the lidar sensor 175 at each location.

Further, the map generation module 143 may generate the map based on information obtained through the obstacle detection sensor 171, and recognize a location based on the information obtained through the obstacle detection sensor 171 at each location.

More preferably, the map generation module 143 may generate the map and perform location recognition based on information obtained through the image acquirer 120 and the lidar sensor 175.

The location recognition module 143 estimates and recognizes the current location. The location recognition module 142 may identify the location in connection with the map generation module 143 by using the image information of the image acquirer 120, and thus may estimate and recognize the current location even when the location of the mobile robot 100 suddenly changes.

The mobile robot 100 is capable of recognizing the location during continuous traveling through the location recognition module 142, and may learn the map and estimate the current location though the traveling control module 141, the map generation module 143, and the obstacle recognition module 144, without the location recognition module 142.

The mobile robot 100 acquires the acquired image through the image acquirer 120 at an unknown current location. Various features such as lights, edges, corners, blobs, ridges and the like located on the ceiling are identified based on the image.

As described above, the controller 140 may classify the traveling area and generate the map composed of a plurality of regions, or recognize the current location of the main body 110 based on the pre-stored map.

In addition, the controller 140 may combine the information obtained through the image acquirer 120 and the lidar sensor 175 to generate the map and perform location recognition.

Upon generating the map, the controller 140 may transmit the generated map to the external terminal, the server, or the like through the communication unit 190. Also, as described above, the controller 140 may store the map in the storage unit 130 when the map is received from the external terminal, the server, or the like.

In addition, when the map is updated while traveling, the controller 140 transmits the updated information to an external terminal so that the map stored in the external terminal is the same as the one stored in the mobile robot 100. As the map stored in the external terminal and the mobile robot 100 remains the same, the mobile robot 100 may clean the designated area in response to a cleaning command from the mobile terminal, and the current location of the mobile robot 100 may be displayed on the external terminal.

In this case, the cleaning area of the map is divided into a plurality of areas, and the map may include a connection path connecting the plurality of areas and information on obstacles in the area.

When the cleaning command is input, the controller 140 determines whether the location on the map and the current location of the mobile robot match. The cleaning command may be input from a remote control, an operation unit or the external terminal.

If the current location does not match the location on the map, or if the current location may not be confirmed, the controller 140 recognizes the current location and restores the current location of the mobile robot 100, and then the controller 140 may control the traveling unit 140 to move to the designated area based on the current location.

If the current location does not match the location on the map, or if the current location may not be confirmed, the location recognition module 142 analyzes the acquired image input from the image acquirer 120 and/or the terrain information obtained by the lidar sensor 175 and estimates the current location based on the map. In addition, the obstacle recognition module 144 or the map generation module 143 may also recognize the current location in the same manner.

After recognizing the location and restoring the current location of the mobile robot 100, the traveling control module 141 calculates a traveling route from the current location to the designated area and controls the traveling unit 160 to move to the designated area.

When receiving the cleaning pattern information from the server, the traveling control module 141 may divide the entire traveling area into a plurality of areas and set one or more areas as designated areas according to the received cleaning pattern information.

In addition, the traveling control module 141 may calculate the traveling route according to the received cleaning pattern information, and perform cleaning while traveling along the traveling route.

When the cleaning of the set designated area is completed, the controller 140 may store a cleaning record in the storage unit 130.

In addition, the controller 140 may transmit the operation state or the cleaning state of the mobile robot 100 to the external terminal or the server at predetermined intervals through the communication unit 190.

Accordingly, the external terminal displays the location of the mobile robot 100 along with the map on the screen of the running application based on the received data, and also outputs information about the cleaning state.

The mobile robot 100 according to an embodiment of the present disclosure moves in one direction until an obstacle or a wall surface is sensed, and when the obstacle recognition module 144 recognizes an obstacle, the robot 100 may determine traveling patterns such as straight and rotating.

For example, if the recognized obstacle attribute is a kind of obstacle that can be passed, the mobile robot 100 may continue to go straight. Alternatively, if the attribute of the recognized obstacle is an obstacle that cannot be passed, the mobile robot 100 rotates to move a certain distance, and then moves to a distance in which the obstacle is detected in the opposite direction of the initial movement direction to travel in a zigzag form.

The mobile robot 100 according to an embodiment of the present disclosure may perform human or object recognition, and avoidance based on machine learning.

The controller 140 may include the obstacle recognition module 144 that recognize an obstacle previously learned by machine learning from an input image, and the traveling control module 141 that controls the traveling of the traveling unit 160 based on the attribute of the recognized obstacle.

The obstacle recognition module 144 may include artificial neural networks (ANN) in the form of software or hardware that has learned attributes of an obstacle.

For example, the obstacle recognition module 144 may include a deep neural network (DNN), such as Convolutional Neural Network (CNN), Recurrent Neural Network (RNN), and Deep Belief Network (DBN) trained through Deep Learning.

The obstacle recognition module 144 may determine the attribute of the obstacle included in input image data based on weights between nodes included in the deep neural network (DNN).

Meanwhile, the mobile robot 100 may further include an output unit 180 to display predetermined information as an image or output it as sound.

The output unit 180 may include a display (not shown) that displays information corresponding to the user's command input, a processing result corresponding to the user's command input, an operation mode, an operation state, and an error state.

In some embodiments, the display may be configured as a touch screen by forming a mutual layer structure with a touch pad. In this case, the display composed of the touch screen may be used as an input device capable of inputting information by a user's touch in addition to the output device.

In addition, the output unit 180 may include an audio output unit (not shown) that outputs an audio signal. Under the control of the controller 140, the sound output unit may output an alert message such as a warning sound, an operation mode, an operation state, an error state, information corresponding to a user's command input, and a processing result corresponding to a user's command input as sound. The audio output unit may convert the electrical signal from the controller 140 into an audio signal and output the converted audio signal. To this end, a speaker or the like may be provided.

Hereinafter, a method of generating a map of the mobile robot 100 of FIG. 1 having the configuration of FIG. 2 will be described.

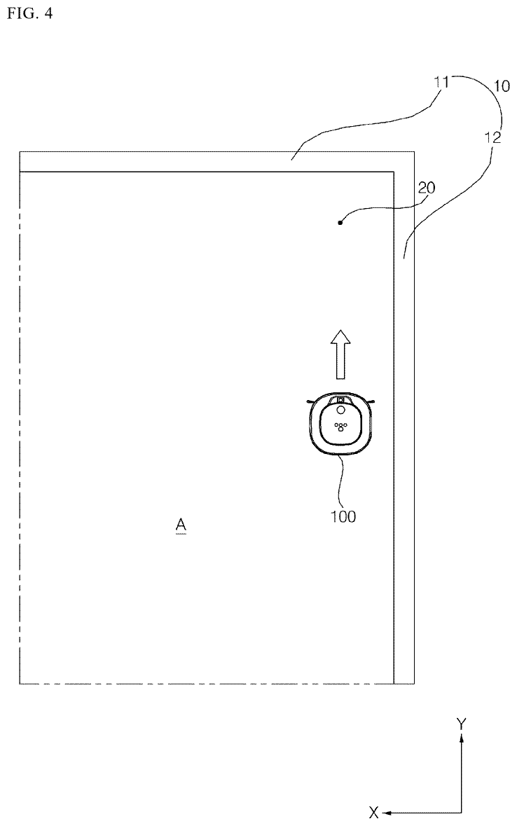

FIG. 3 is a flowchart illustrating a method for controlling the mobile robot 100 according to an embodiment of the present disclosure.

Referring to FIG. 3, the mobile robot 100 according to an embodiment of the present disclosure receives a traveling command for cleaning or service under instructions from the controller 140.

The mobile robot 100 obtains terrain information about the surrounding environment while traveling in the cleaning area according to the traveling command (S10, S11). The controller 140 controls the sensing unit 170 to obtain the terrain information about the surrounding environment.

The present disclosure may be used in the laser-based SLAM. More specifically, the present disclosure may be used in the case where the laser-based SLAM is unavailable due to a dark traveling area, or in the case where there is no lidar sensor or camera sensor in order to reduce costs.

SLAM technology may be divided into vision-based SLAM and laser-based SLAM.

In vision-based SLAM, a feature point is extracted from an image, three-dimensional coordinates are calculated through matching, and SLAM is performed based thereon. When an image has a lot of information and thus the environment is bright, excellent performance is exhibited in self-location recognition. However, in a dark place, operation is difficult, and there is a scale drift problem in which a small object present nearby and a large object present far away are recognized similarly.

In laser-based SLAM, the distance by angle is measured using a laser to calculate geometry in the surrounding environment. The laser-based SLAM works even in a dark environment. However, location is recognized using only geometry information, such that it may be difficult to find its own location when there is no initial location condition in a space having a lot of repetitive areas, such as an office environment. In addition, it is difficult to correspond to a dynamic environment, such as movement of furniture.

That is, in vision-based SLAM, accurate operation is difficult in a dark environment (in an environment having no light). Also, in laser-based SLAM, self-location recognition is difficult in a dynamic environment (a moving object) and a repetitive environment (a similar pattern), accuracy in matching between the existing map and the current frame and loop closing is lowered, and it is difficult to make a landmark, such that it is difficult to cope with a kidnapping situation.

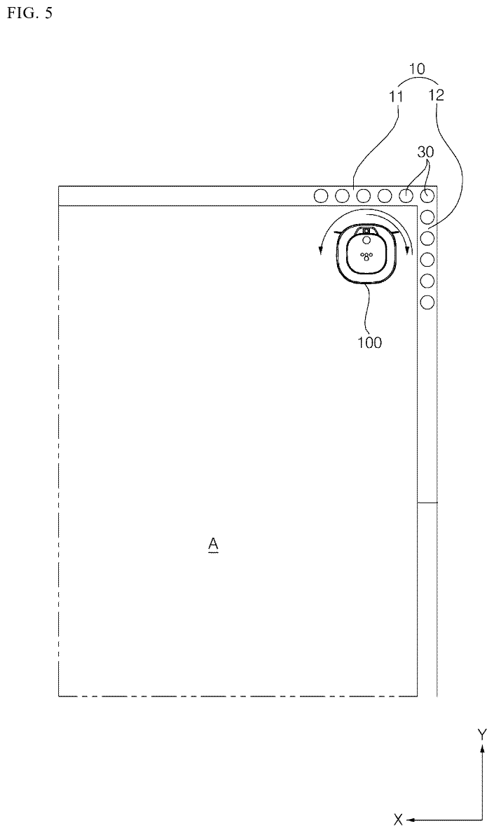

The mobile robot 100 determines whether a current location of the main body 110 is a corner 20 in the traveling area based on the terrain information obtained by the sensing unit 170 (S13). Referring to FIG. 4, the mobile robot 100 travels in the traveling area according to a cleaning mode.

The mobile robot 100 determines whether a current location of the main body 110 is the corner 20 in the traveling area based on information about distances from edges, walls, and obstacles input by the obstacle detection sensor 171. Specifically, the controller 140 may define a point, at which two walls meet, as the corner 20 and may determine that a current location of the main body 110, at which the main body 110 is located within a predetermined distance from the corner 20, is the corner 20.

In the case where the current location of the main body 110 is the corner 20, the mobile robot 100 obtains, at the corner 20, terrain information around the corner 20 (S14).

Specifically, in the case where the main body 110 is positioned at the corner 20, the controller 140 controls a motion for obtaining corner surrounding information to be performed at the corner 20 to obtain terrain information around the corner 20 by the sensing unit 170.

In the case where the main body 110 is positioned at the corner 20 during wall following traveling of the main body 110, the controller 140 may perform the motion for obtaining the corner surrounding information. In addition, the controller 140 may perform the motion in the case where the main body 110 is positioned at the corner 20 while the mobile robot 100 travels for cleaning.

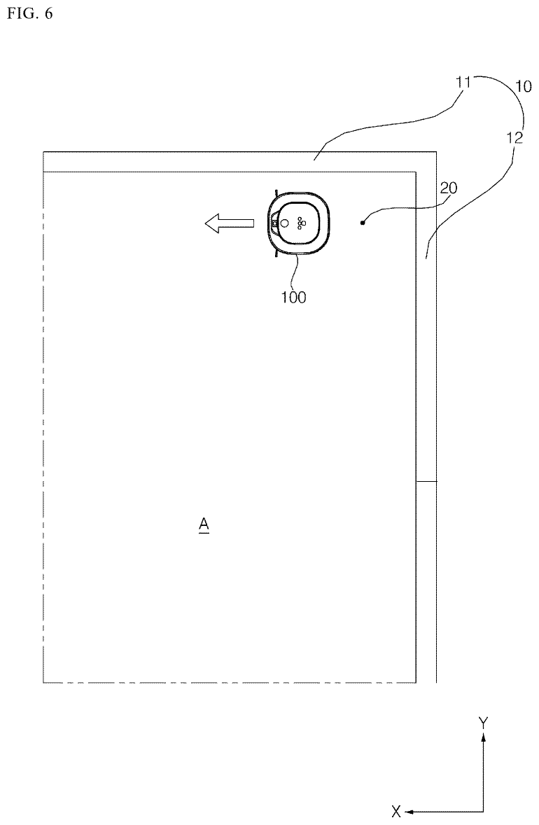

The controller 140 controls the mobile robot 100 to perform the motion for obtaining the corner surrounding information each time the mobile robot 100 is positioned at the corner 20. Referring to FIG. 5, the motion for obtaining the corner surrounding information is performed in which external terrain information may be obtained by the sensing unit 170 while the main body 110 rotates at the corner 20.

Specifically, in the case where the main body 110 is positioned at the corner 20, the controller 140 controls the main body 110 to rotate clockwise or counterclockwise in place, and at the same time controls the sensing unit 170 to obtain external terrain information. The controller 140 may control the main body 110 to rotate 360 degrees in place, but there is a problem in that the rotation may increase cleaning time.

Referring to FIG. 5, in order to overcome such problem, the motion for obtaining the corner surrounding information is performed in such a manner that the main body 110 rotates at the corner 20 in a first direction, and then rotates in a second direction opposite to the first direction to obtain external terrain information by the sensing unit 170. In other words, the motion for obtaining the corner surrounding information is performed in such a manner that the main body 110 rotates at the corner 20 until the front of the main body 110 faces the first direction, and then rotates until the front faces the second direction, to obtain the external terrain information by the sensing unit 170.

More specifically, the first direction and the second direction are orthogonal to a traveling direction (heading direction) of the main body 110, and the second direction may match the traveling direction (heading direction) of the main body 110 after the main body 110 travels around the corner 20. Accordingly, the main body 110 obtains surrounding information of the corner 20 while rotating 270 degrees at the corner 20, thereby achieving the effect of reducing cleaning time and sensing time compared to a 360-degree rotation, and a direction angle of the mobile robot 100 after completing the rotation is the heading direction of the mobile robot 100, thereby achieving the effect of increasing cleaning efficiency.

That is, as illustrated in FIG. 5, the mobile robot 100 obtains terrain information around the corner 20 by traveling in the Y-axis direction, and upon encountering the corner 20, rotating 90 degrees clockwise in place to the −X axis direction (first direction), and then rotating 180 degrees counterclockwise to the X-axis direction.

The obstacle detection sensor 171 is generally installed at the front of the main body 110 so as to detect a distance from an obstacle or wall within a predetermined range of angles (approximately 2 to 8 degrees) relative to the front side. In addition, two or three obstacle detection sensors 171 are generally installed in order to reduce installation costs and improve sensing efficiency.

The limitation in sensing angle of the obstacle detection sensor 11 may be overcome with the terrain information around the corner 20 which is obtained by rotating the main body 110. When obtaining the terrain information around the corner 20, the controller 140 extracts feature points of an obstacle (e.g., wall) adjacent to the corner 20 while rotating the main body 110 in clockwise and counterclockwise directions as described above, and obtains angle values of the extracted feature points and distance values with respect to the main body 110.

In addition, the motion for obtaining the corner surrounding information is performed to obtain terrain information by extracting distances from the feature points of the wall 10 within a predetermined distance and a predetermined angle from the corner 20.

The controller 140 may estimate a current location of the main body 110 based on the terrain information around the corner 20 which is obtained by performing the motion for obtaining the corner surrounding information (S14).

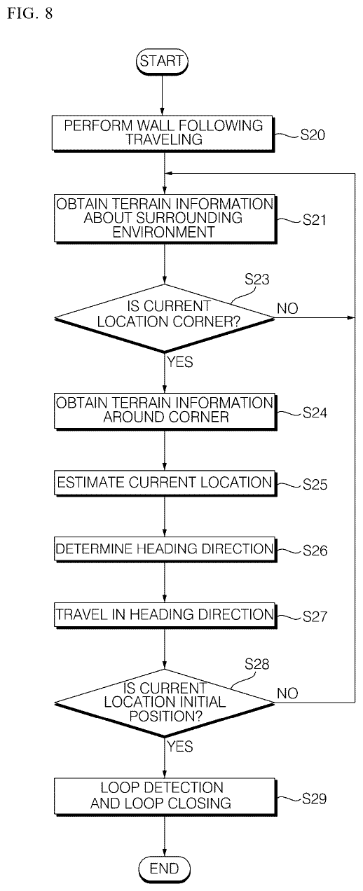

The controller 140 may estimate the current location of the main body 110 based on distances from the feature points of the wall. Specifically, referring to FIG. 7, the controller 140 may estimate the current location of the mobile robot 100 by matching position information of the wall around the corner 20, which is stored in a map, with the terrain information around the corner 20 which is obtained by performing the motion for obtaining surrounding information of the corner 20.

More specifically, the controller 140 may estimate the current location of the mobile robot 100 at the corner 20 by estimating an inclination of the wall based on distances to the feature points of the wall, and matching the slope of the wall with wall inclinations stored in the map.

Alternatively, the controller 140 may estimate the current location of the mobile robot 100 at the corner 20 by matching position information of the feature points of the wall adjacent to the corner 20 with position information of feature points of the wall stored in the map. There is no limitation in the matching method, but Particle Swarm Optimization (PSO) or Iterative Closest Point (ICP) may be used.

Even more specifically, the controller 140 may estimate the current location of the mobile robot 100 by matching a corner feature point 32 obtained corresponding to the corner 20 during the motion for obtaining the surrounding information of the corner 20, first feature points 31 obtained for a first wall 11, second feature points 33 obtained for a second wall 12, and a first feature point 41 and a second feature point 43.

Accordingly, in the present disclosure, SLAM may be performed by using only one to three laser-based obstacle detection sensors 171 installed on the main body 110, such that the current location of the mobile robot 100 may be accurately estimated at the corner 20 while reducing manufacturing costs of the mobile robot 100, thereby achieving the effect of accurate and rapid traveling.

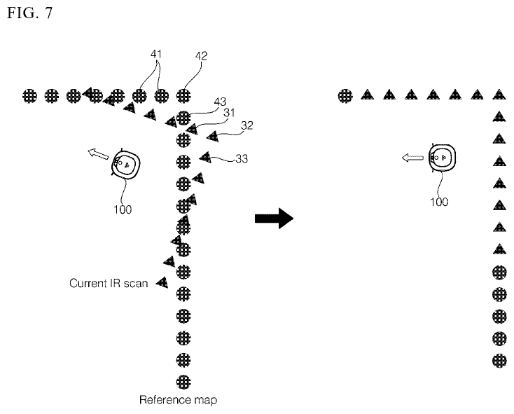

The controller 140 determines a heading direction of the mobile robot 100 after the motion for obtaining the corner surrounding information, based on the estimated current location of the mobile robot 100 and a direction angle (S16). Specifically, the controller 140 estimates an inclination of the wall based on distances to the feature points of the wall, and may determine a heading direction of the mobile robot 100 to be a direction parallel to the inclination of the wall. As illustrated in FIG. 6, the controller 140 determines the heading direction of the mobile robot 100 after the motion for obtaining the corner surrounding information to be an X-axis direction parallel to the first wall 11.

The controller 140 controls the traveling unit so that the main body 110 travels in the determined heading direction of the mobile robot 100 (S17).

The controller 140 may update a pre-stored map based on the terrain information around the corner 20 which is obtained by performing the motion for obtaining the corner surrounding information (S18).

The controller 140 may estimate the inclination of the wall based on the distances to the feature points of the wall, may update the inclination of the wall in the map, and may update position information of each corner 20 in the map.

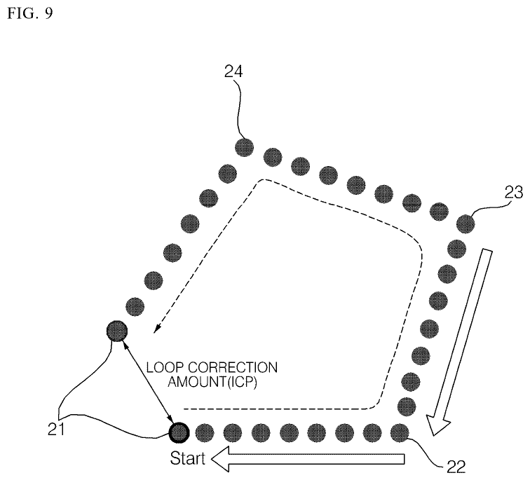

FIG. 8 is a diagram illustrating a method of controlling the mobile robot 100 according to another embodiment of the present disclosure.

Referring to FIG. 8, the mobile robot 100 according to an embodiment of the present disclosure receives a traveling command for generating a map under instructions from the controller 140.

The mobile robot 100 acquires detection information about the surrounding environment while traveling in the cleaning area according to the traveling command. Specifically, the mobile robot 100 may perform wall following traveling for generating a map (S20 and S21).

The mobile robot 100 determines whether the current location of the main body 110 is the corner 20 in the traveling area, based on the terrain information obtained by the sensing unit 170 (S23).

The mobile robot 100 determines whether the current location of the mobile robot 100 is the corner 20 based on information about distances from edges, walls, and obstacles input by the obstacle detection sensor 171. Specifically, the controller 140 defines a point, at which two walls meet, as the corner 20, and determines that a current location of the main body 110, at which the main body 110 is located within a predetermined distance from the corner 20, is the corner 20.

In the case where the current location of the main body 110 is the corner 20, the mobile robot 100 obtains, at the corner 20, terrain information around the corner 20 (S24).

Specifically, in the case where the main body 110 is positioned at the corner 20, the controller 140 controls the motion for obtaining corner surrounding information to be performed at the corner 20 to obtain the terrain information around the corner 20 by the sensing unit 170.

The controller 140 controls the mobile robot 100 to perform the motion for obtaining the corner surrounding information each time the mobile robot 100 is positioned at the corner 20.

In addition, the motion for obtaining the corner surrounding information is performed to obtain terrain information by extracting distances from the feature points of the wall 10 within a predetermined distance and a predetermined angle from the corner 20.

The controller 140 may estimate a current location of the main body 110 based on the terrain information around the corner 20 which is obtained by performing the motion for obtaining the corner surrounding information (S25). The method of estimating the current location of the main body 110 based on the terrain information around the corner 20 is the same as the embodiment of FIG. 3.

The controller 140 determines a heading direction of the mobile robot 100 after the motion for obtaining the corner surrounding information, based on the estimated current location of the mobile robot 100 and a direction angle (S26).

The controller 140 controls the traveling unit so that the main body 110 travels in the determined heading direction of the mobile robot 100 (S27).

The controller 140 determines whether the current location of the mobile robot 100 is an initial position (S28).

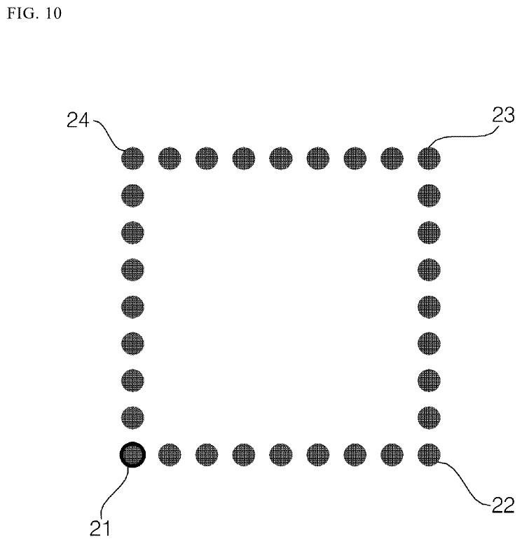

Referring to FIGS. 9 and 10, in the case in which the current location of the mobile robot 100 is the initial position, the controller 140 performs loop detection and loop closing based on the position information of each corner 20 and the terrain information around the corner 20 which is obtained for each corner 20 (S29).

Loop closing is performed using the Explicit Loop Closing Heuristics (ELCH) or Iterative Closest Points (ICP) method based on a loop correction amount (S30). By performing loop closing, a loop with four corners 21, 22, 23, and 24 is generated.

The controller 140 generates a new map based on the loop closing, and stores the new map in a storage or transmits the new map to a server.

Accordingly, in the present disclosure, only two to three obstacle detection sensors 171 are used at the front of the main body 110, thereby resulting in a simple structure and low manufacturing costs, and a new map of a traveling area may be generated accurately and relatively rapidly.

While the present disclosure has been shown and described with reference to the preferred embodiments thereof, it should be understood that the present disclosure is not limited to the aforementioned specific embodiments, and various modifications and variations may be made by those skilled in the art without departing from the scope and spirit of the invention as defined by the appended claims, and the modified implementations should not be construed independently of the technical idea or prospect of the present disclosure.

1. A mobile robot comprising:
a main body;
a traveling unit configured to move the main body;
a sensing unit configured to obtain terrain information outside the main body; and
a controller which is configured to determine whether a current location of the main body is a corner in a traveling area based on the terrain information obtained by the sensing unit, and which in response to the main body being positioned at the corner, is configured to control a motion for obtaining corner surrounding information to be performed at the corner to obtain terrain information around the corner by the sensing unit.

2. The mobile robot of claim 1, wherein the motion for obtaining the corner surrounding information is performed in such a manner that the main body rotates at the corner to obtain external terrain information by the sensing unit.

3. The mobile robot of claim 1, wherein the motion for obtaining the corner surrounding information is performed in such a manner that the main body rotates in a first direction at the corner, and then rotates in a second direction opposite to the first direction, to obtain external terrain information by the sensing unit.

4. The mobile robot of claim 3, wherein the first direction and the second direction are orthogonal to a traveling direction of the main body.

5. The mobile robot of claim 3, wherein the second direction matches a traveling direction after the main body travels around the corner.

6. The mobile robot of claim 1, wherein the sensing unit comprises a laser sensor for obtaining terrain information within a predetermined angle with respect to the traveling direction of the main body.

7. The mobile robot of claim 6, wherein the motion for obtaining the corner surrounding information comprises obtaining the terrain information by extracting distances to feature points of a wall within a predetermined distance or a predetermined angle from the corner.

8. The mobile robot of claim 7, wherein the controller is configured to estimate an inclination of the wall based on the distances to the feature points of the wall, and to update the inclination of the wall in a map.

9. The mobile robot of claim 7, wherein the controller is configured to estimate a current location of the main body based on the distances to the feature points of the wall.

10. The mobile robot of claim 9, wherein the controller is configured to estimate an inclination of the wall based on the distances to the feature points of the wall, and to determine a heading direction of the main body based on the inclination of the wall.

11. The mobile robot of claim 1, wherein the controller is configured to estimate a current location of the main body based on the terrain information around the corner obtained by performing the motion for obtaining the corner surrounding information.

12. The mobile robot of claim 1, further comprising a storage unit configured to store data,
wherein the controller is configured to update the map based on the terrain information around the corner obtained by performing the motion for obtaining the corner surrounding information.

13. The mobile robot of claim 1, further comprising a storage unit configured to store data,
wherein the controller is configured to generate a map based on terrain information around a plurality of corners and position information of the plurality of corners, the terrain information and the position information being obtained by performing the motion for obtaining the corner surrounding information.

14. The mobile robot of claim 13, wherein the controller is configured to estimate a current location of the main body based on the terrain information around the corner obtained by performing the motion for obtaining the corner surrounding information.

15. The mobile robot of claim 1, wherein the controller is configured to perform the motion for obtaining the corner surrounding information during wall following traveling of the main body.

16. A method for controlling a mobile robot, the method comprising:
a terrain information obtaining step of obtaining, by a sensing unit, terrain information around a main body;
a corner determining step of determining whether a current location of the main body is a corner in a traveling area; and
a corner surrounding terrain information obtaining step of obtaining, at the corner, terrain information around the corner in response to the current location of the main body being the corner.

17. The method of claim 16, wherein the corner surrounding terrain information obtaining step comprises obtaining external terrain information by the sensing unit while the main body rotates at the corner.

18. The method of claim 16, further comprising a current location estimating step of estimating a current location of the main body based on the terrain information around the corner.

19. The method of claim 16, further comprising a map updating step of updating a map based on the terrain information around the corner.

20. The method of claim 16, wherein the corner surrounding terrain information obtaining step comprises extracting distances to feature points of a wall within a predetermined distance and a predetermined angle from the corner.
